(19) United States
(12) Patent Application Publication
(10) Pub. No.: US 2026/0369481 A1
(43) Pub. Date: Nov. 19, 2026

(54) POWER SUPPLY UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tatsuya SUMIDA, Mie (JP)

(21) Appl. No.: 19/142,959

(22) PCT Filed: Dec. 27, 2022
(86) PCT No.: PCT/JP2022/048313

§ 371 Date: Jun. 25, 2025

(51) Int. Cl. H01G 11/18; H01G 11/10; H01G 11/82

(52) U.S. Cl. CPC H01G 11/18; H01G 11/10; H01G 11/82

(57) ABSTRACT

A power supply unit includes a printed circuit board accommodated in a case and a capacitor mounted on the printed circuit board. The capacitor includes a pair of electrodes on both end surfaces in an axial direction of a tubular body. A metal flat plate is electrically conductively fixed to each electrode. Each metal flat plate includes a connecting portion inserted into and soldered to a through-hole of the printed circuit board. At least one of the metal flat plates includes a press-fitting portion to be press-fit into a press-fitting hole of the printed circuit board. The capacitor is fixedly held on the printed circuit board by press-fitting the press-fitting portion into the press-fitting hole.

### TECHNICAL FIELD

The present disclosure relates to a power supply unit.

### BACKGROUND

Conventionally, a power supply unit using a capacitor is known as an auxiliary power supply installed in a vehicle such as an electric vehicle or a hybrid vehicle and used as an auxiliary power supply during a temporary voltage drop of a battery or the like. For example, Patent Document 1 discloses a power supply unit structured to be mounted on a printed circuit board with a plurality of capacitors held in a holder made of synthetic resin.

### PRIOR ART DOCUMENT

### Patent Document

Patent Document 1: JP 2016-081795 A

### SUMMARY OF THE INVENTION

### Problems to be Solved

However, since the holder made of synthetic resin for holding the plurality of capacitors is necessary in the structure of Patent Document 1, the number of components is large and a problem that the enlargement of the power supply unit itself is unavoidable has been inherent. Further, accurate dimension settings are required not to cause rattling for a locking structure of the capacitors provided in the holder so that an external force is not applied to leads (connecting portions) of the capacitors soldered to through-holes of the printed circuit board by the vibration of the capacitor. As a result, mold cost and the like for the holder have increased, whereby an increase in manufacturing cost has been unavoidable. Further, since the capacitor of a so-called radial type in which a pair of the leads (connecting portions) project from one end surface in an axial direction of a tubular body of the capacitor is used, the other side in the axial direction of the tubular body is easily shaken and the capacitor is structured to easily vibrate.

Accordingly, a power supply unit is disclosed which can suppress the vibration of a capacitor while reducing the number of components and cost and realizing a size reduction.

### Means to Solve the Problem

The present disclosure is directed to a power supply unit with a printed circuit board accommodated in a case and a capacitor mounted on the printed circuit board, the capacitor including a pair of electrodes on both end surfaces in an axial direction of a tubular body, a metal flat plate being electrically conductively fixed to each electrode, each metal flat plate including a connecting portion to be inserted into and soldered to a through-hole of the printed circuit board, at least one of the metal flat plates including a press-fitting portion to be press-fit into a press-fitting hole of the printed circuit board, and the capacitor being fixedly held on the printed circuit board by press-fitting the press-fitting portion into the press-fitting hole.

Effect of the Invention According to the power supply unit of the present disclosure, it is possible to suppress the vibration of the capacitor while reducing the number of components and cost and realizing a size reduction.

### BRIEF DESCRIPTION OF THE DRAWINGS

FIG. 1 is a perspective view showing a power supply unit according to one embodiment.

FIG. 2 is a plan view of the power supply unit shown in FIG. 1.

FIG. 3 is a right side view enlargedly showing an essential part of the power supply unit shown in FIG. 1 with a case removed.

FIG. 4 is a vertical section enlargedly showing an essential part in a cross-section along IV-IV of FIG. 2.

FIG. 5 is a vertical section enlargedly showing the essential part in a cross-section along V-V of FIG. 2.

FIG. 6 is a vertical section enlargedly showing the essential part in a cross-section along VI-VI of FIG. 2.

FIG. 7 is an exploded perspective view of the power supply unit shown in FIG. 1.

FIG. 8 is a perspective view showing an upper case constituting the case in the power supply unit shown in FIG. 1 from a bottom surface side.

FIG. 9 is a plan view enlargedly showing an essential part of a printed circuit board constituting the power supply unit shown in FIG. 1.

FIG. 10 is a perspective view showing a capacitor constituting the power supply unit shown in FIG. 1 from one end surface side in an axial direction.

FIG. 11 is a perspective view showing the capacitor constituting the power supply unit shown in FIG. 1 from the other end surface side in the axial direction.

FIG. 12 is a perspective view showing an electrolyte container constituting the power supply unit shown in FIG. 1.

### DETAILED DESCRIPTION TO EXECUTE THE INVENTION

### Description of Embodiments of Present Disclosure

First, embodiments of the present disclosure are listed and described.

(1) The power supply unit of the present disclosure is provided with a printed circuit board accommodated in a case and a capacitor mounted on the printed circuit board, the capacitor including a pair of electrodes on both end surfaces in an axial direction of a tubular body, a metal flat plate being electrically conductively fixed to each electrode, each metal flat plate including a connecting portion to be inserted into and soldered to a through-hole of the printed circuit board, at least one of the metal flat plates including a press-fitting portion to be press-fit into a press-fitting hole of the printed circuit board, and the capacitor being fixedly held on the printed circuit board by press-fitting the press-fitting portion into the press-fitting hole.

According to the power supply unit of the present disclosure, a capacitor of a so-called axial type is adopted as the capacitor provided with the pair of electrodes on the both end surfaces in the axial direction of the tubular body. The metal flat plate provided with the connecting portion to be inserted into and soldered to the through hole of the printed circuit board is electrically conductively fixed to each of the pair of electrodes on the both end surfaces in the axial direction of the capacitor. By press-fitting the press-fitting portion provided on at least one metal flat plate into the press-fitting hole of the printed circuit board, the capacitor is fixedly held on the printed circuit board. That is, the capacitor can be fixedly held on the printed circuit board, making a good use of the rigidity of the metal flat plate fixed to the electrode of the capacitor and a press-fitting force of the press-fitting portion of the metal flat plate into the press-fitting hole of the printed circuit board. As a result, a capacitor holder made of synthetic resin, which has been conventionally necessary, can be made unnecessary, and a power supply unit capable of a reduction in the number of components, a cost reduction and a size reduction can be provided.

Further, the pair of electrodes of the capacitor are separately provided on both ends in the axial direction of the tubular body, and the connecting portions of the metal flat plates fixed to the electrodes are soldered to the through-holes of the printed circuit board. Thus, a structural problem that the other side in an axial direction of a capacitor including electrodes like a conventional capacitor of a radial type including leads (connecting portions) only on one side in the axial direction is easily shaken is solved. In this way, the vibration of the capacitor can be suppressed and a possibility of cracks and the like in solder for connecting the connecting portion to the through-hole can be suppressed.

Note that the press-fitting portion may be provided on at least one metal flat plate, but more stable fixing of the capacitor to the printed circuit board may be realized by providing the press-fitting portion on each metal flat plate.

Further, an arbitrary method can be adopted as a method for fixing the metal flat plates to the pair of electrodes of the capacitor if the metal flat plates can be fixed in an electrically conductive state. For example, welding, crimping and the like can be suitably adopted.

(2) Preferably, in (1) described above, each metal flat plate includes the press-fitting portion. Since the press-fitting portion is provided on each of the pair of metal flat plates fixed to the electrodes on the both end surfaces in the axial direction of the capacitor, the capacitor can be more stably fixed to the printed circuit board by press-fitting the press-fitting portions into the press-fitting holes. Moreover, the press-fitting portion can be provided near each connecting portion, the influence of an external force on the solder for connecting the connecting portion to the through-hole can be advantageously suppressed, and the connection stability of the capacitor and the printed circuit board can be improved.

(3) Preferably, in (1) or (2) described above, each metal flat plate includes a stopper portion for specifying an insertion amount of the connecting portion into the through-hole by being placed on the printed circuit board and a gap spreading upward is formed around the connecting portion with the stopper portion placed on the printed circuit board. The connecting portion can be inserted into the through-hole by a necessary amount and assembly workability can be improved only by placing the stopper portions provided on the metal flat plates on the printed circuit board. Further, since the gap spreading upward is formed around the connecting portion with the stopper portion placed on the printed circuit board, solder wicking in soldering the connecting portion to the through-hole can be promoted and satisfactory soldering can be realized. Moreover, solder wicking can be easily confirmed through the gap from outside, and an inspection work and the like can also be satisfactorily performed.

(4) Preferably, in (3) described above, the press-fitting portion press-fit into the press-fitting hole is soldered and a gap spreading upward is formed around the press-fitting portion with the stopper portion placed on the printed circuit board. By soldering the press-fitting portions to the press-fitting holes, the capacitor can be more stably fixed to the printed circuit board. In addition, since the gaps spreading upward are formed around the press-fitting portions with the stopper portions placed on the printed circuit board, solder wicking in soldering the press-fitting portions into the press-fitting holes can be promoted and satisfactory soldering can be realized. Moreover, solder wicking can be easily confirmed through the gaps from outside and an inspection work and the like can also be satisfactorily performed.

(5) Preferably, in any one of (1) to (4) described above, a central part in a length direction of the metal flat plate including the press-fitting portion constitutes a welded portion to be overlapped on and welded to the electrode, both side parts in the length direction thereof constitute a pair of projecting plate portions projecting outward in the axial direction of the tubular body by being bent in a plate thickness direction, the press-fitting portion is provided to project toward the printed circuit board from a lower end part of each of the pair of projecting plate portions, and each press-fitting portion is press-fit into the press-fitting hole.

The welded portion to be welded to the electrode is provided in the central part in the length direction of the metal flat plate, and the both sides in the length direction of the metal flat plate constitute the pair of projecting plate portions projecting outward in the axial direction. The press-fitting portion is provided in the lower end part of each projecting plate portion and press-fit into the press-fitting hole. In this way, the press-fitting portions can be distributed and arranged at two positions separated in a direction orthogonal to an axis of the tubular body of the capacitor and separated outward from the electrode in the axial direction. In this way, the capacitor can be more stably fixed to the printed circuit board. Particularly, in the case of combination with (2) described above, fixing points of the capacitor to the printed circuit board can be secured at at least four or more points on the both ends in the axial direction and both sides in the direction orthogonal to the axis of the capacitor and a more stably fixed state can be realized. Note that one press-fitting portion provided in the lower end part of each projecting plate portion is sufficient, but a plurality of the press-fitting portions may be provided.

(6) Preferably, in any one of (1) to (5) described above, each metal flat plate includes a stopper portion for specifying an insertion amount of the connecting portion into the through-hole by being placed on the printed circuit board, a central part in a length direction thereof constitutes a welded portion to be overlapped on and welded to the electrode, both side parts in the length direction thereof constitute a pair of projecting plate portions projecting outward in the axial direction of the tubular body by being bent in a plate thickness direction, and the stopper portion is provided to project toward the printed circuit board from a lower end part of each of the pair of projecting plate portions. The stopper portions can be arranged at a total of four positions on the both sides in the axial direction at two positions separated in the direction orthogonal to the axis of the tubular body of the capacitor and at positions separated outward from the electrodes in the axial direction. In this way, the inclination of the capacitor with respect to the printed circuit board can be prevented and the capacitor can be more stably positioned with respect to the printed circuit board.

(7) Preferably, in (5) or (6) described above, the connecting portion is provided to project toward the printed circuit board from a lower end part of the central part in the length direction of the metal flat plate. The connecting portions can be provided near the welded portions to the electrodes, and the conduction stability of the capacitor and the printed circuit board can be advantageously ensured.

(8) Preferably, in any one of (5) to (7) described above, a gas exhaust valve for discharging a gas generated at time of abnormality is provided in one of the both end surfaces of the capacitor, the welded portion of the metal flat plate is arranged around the gas exhaust valve, guiding grooves for guiding an electrolyte by extending toward the printed circuit board are constituted by a pair of concavely bent parts coupling the welded portion of the metal flat plate and the pair of projecting plate portions, and each projecting plate portion is provided with the connecting portion and a cut portion and the guiding groove and the connecting portion are separated in the axial direction by the cut portion.

The metal flat plate to be welded to the negative electrode where the gas exhaust valve is provided may cause a conduction failure or the like if the electrolyte oozing out during the discharge of the gas from the gas exhaust valve when the capacitor is in an abnormal state adheres to the connecting portion. In this mode, the guiding grooves extending toward the printed circuit board are constituted by the pair of concavely bent parts coupling the welded portion and the pair of projecting plate portions of the metal flat plate. Thus, even if the electrolyte oozes out from the gas exhaust valve, the electrolyte is guided toward the printed circuit board along the guiding grooves from the welded portion. As a result, the spread of the electrolyte toward the projecting plate portions is hindered or suppressed, and a failure of the electrolyte flowing to the connecting portions provided on the projecting plate portions can be advantageously hindered or suppressed. In addition, since the guiding groove and the connecting portion are separated by the cut portion in the projecting plate portion, even if the electrolyte spreads beyond the guiding groove, a failure of the spread of the electrolyte to the connecting portion can be hindered or suppressed by the cut portion.

(9) Preferably, in (8) described above, an electrolyte container for storing the electrolyte oozing out from the gas exhaust valve is arranged below the gas exhaust valve and the guiding grooves on the printed circuit board. The spread of the electrolyte flowing down toward the printed circuit board onto the printed circuit board is hindered or suppressed by the electrolyte container. In this way, the occurrence of a conduction failure and the like in the power supply unit can be prevented and safety can be improved.

(10) Preferably, in any one of (1) to (9) described above, a gas exhaust valve for discharging a gas generated at time of abnormality is provided in one of the both end surfaces of the capacitor, and an electrolyte container for storing an electrolyte discharged from the gas exhaust valve is arranged below the gas exhaust valve on the printed circuit board. Even if the electrolyte oozes out from the gas exhaust valve of the capacitor, the oozing-out electrolyte is stored in the electrolyte container and the spread thereof onto the printed circuit board is hindered or suppressed. In this way, the occurrence of a conduction failure and the like in the power supply unit can be prevented and safety can be improved.

### Details of Embodiment of Present Disclosure

A specific example of a power supply unit of the present disclosure is described below with reference to the drawings. Note that the present disclosure is not limited to these illustrations, but is represented by claims and intended to include all changes in the scope of claims and in the meaning and scope of equivalents.

### Embodiment

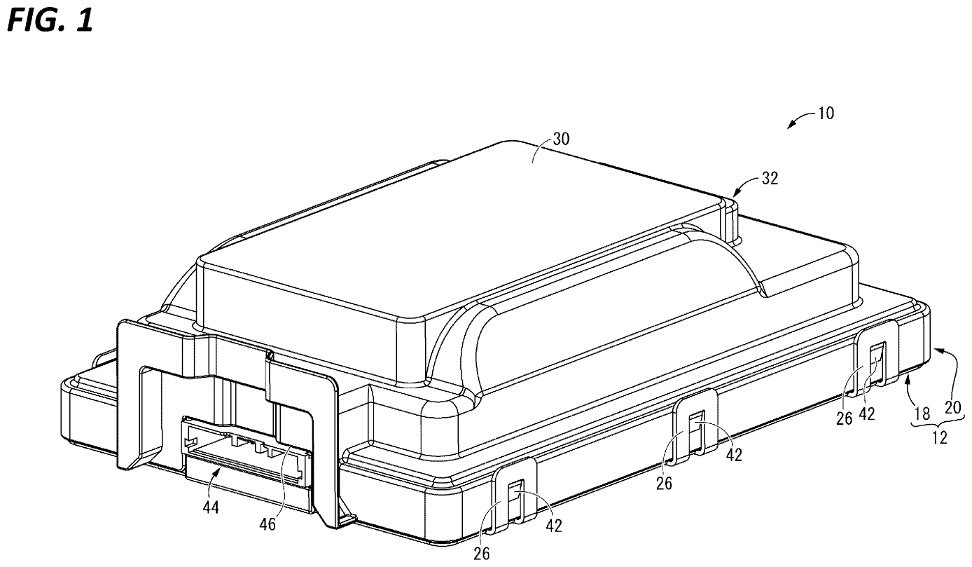

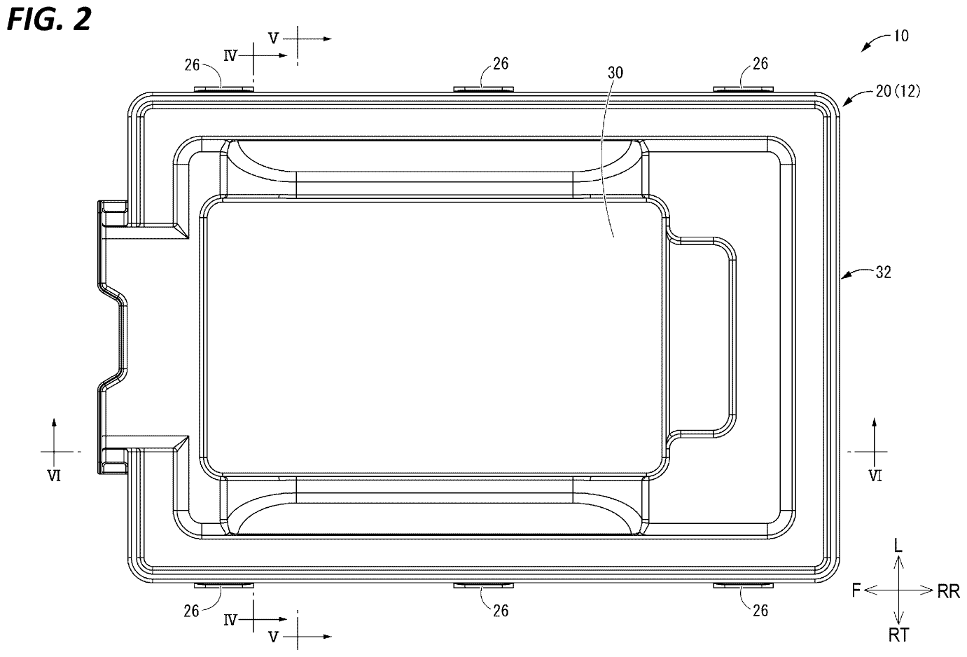

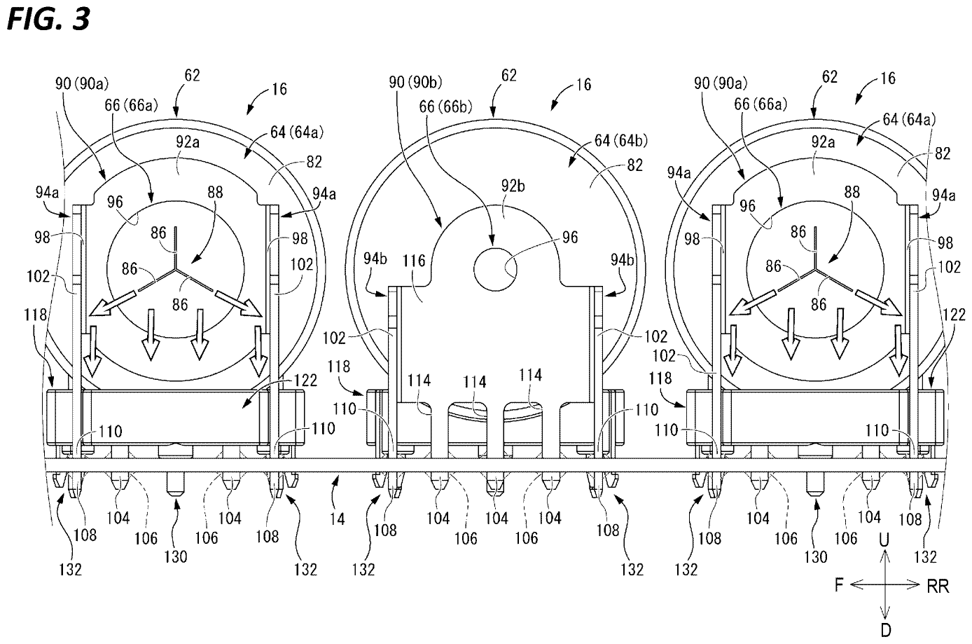

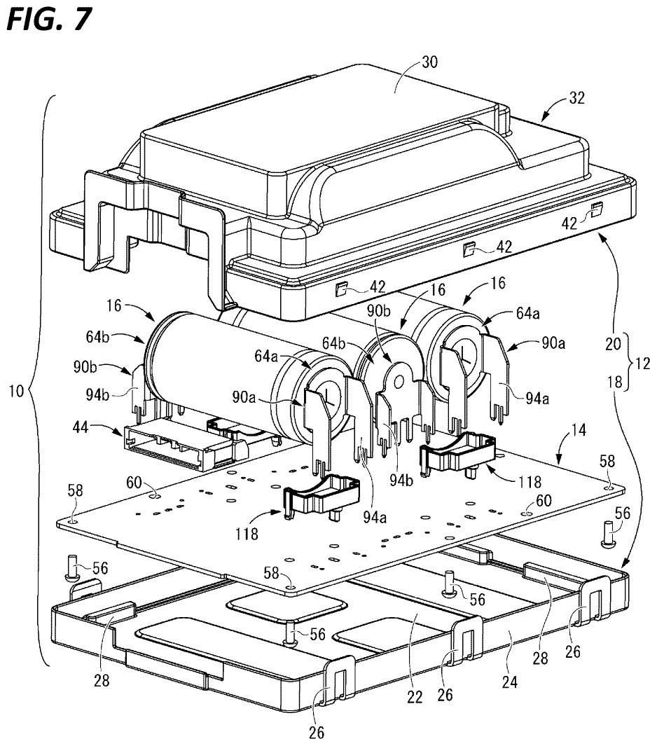

Hereinafter, a power supply unit 10 of one embodiment of the present disclosure is described using FIGS. 1 to 12. The power supply unit 10 of this embodiment is used as a multifunctional backup power supply unit of a system such as a steer-by-wire (SBW) system, a brake system and an electric power steering (EPS) system, for example, during a power supply fault of an electric vehicle, a hybrid vehicle or the like, and has a high capacity. Note that although the power supply unit 10 can be arranged in an arbitrary orientation, upper and lower sides in FIG. 3 are referred to as upper and lower sides, upper and lower sides in FIG. 2 are referred to as left and right sides and left and right sides in FIG. 2 are referred to as front and rear sides in the following description. Further, for a plurality of identical members, only some members may be denoted by a reference sign and the other members may not be described by the reference sign in the following description.

### Power Supply Unit 10

The power supply unit 10 is provided with a printed circuit board 14 accommodated in a case 12 and capacitors 16 mounted on the printed circuit board 14. In this embodiment, three capacitors 16 are provided and arranged in parallel in a front-rear direction with a center axis direction of each capacitor 16 having a substantially hollow cylindrical shape extending in a lateral direction. Note that, out of the three capacitors 16, the middle capacitor 16 is arranged in a state laterally inverted with respect to the capacitors 16 on both sides. That is, a negative electrode 66a and a positive electrode 66b of the middle capacitor 16 are provided on sides opposite to those of the capacitors 16, 16 on the both sides.

### Case 12

In this embodiment, the case 12 is composed of a substantially box-shaped lower case 18 open upward and a substantially box-shaped upper case 20 open downward while covering an upper opening of the lower case 18. These lower case 18 and upper case 20 can be, for example, made of arbitrary materials including synthetic resins, metals and the like. In this embodiment, the lower case 18 and the upper case 20 are made of synthetic resin.

The lower case 18 includes a bottom wall portion 22 substantially rectangular in a plan view and a lower peripheral wall portion 24 projecting upward from an outer peripheral edge part of the bottom wall portion 22. Engaging frame bodies 26 projecting upward and resiliently deformable in the lateral direction are provided at a plurality of positions on both left and right sides of the lower peripheral wall portion 24. Further, a thickness of the lower peripheral wall portion 24 is increased at a plurality of peripheral positions in a lower end part of the lower peripheral wall portion 24, thereby providing lower contact portions 28 for contacting and supporting the printed circuit board 14 from below when the printed circuit board 14 is fixed in the case 12.

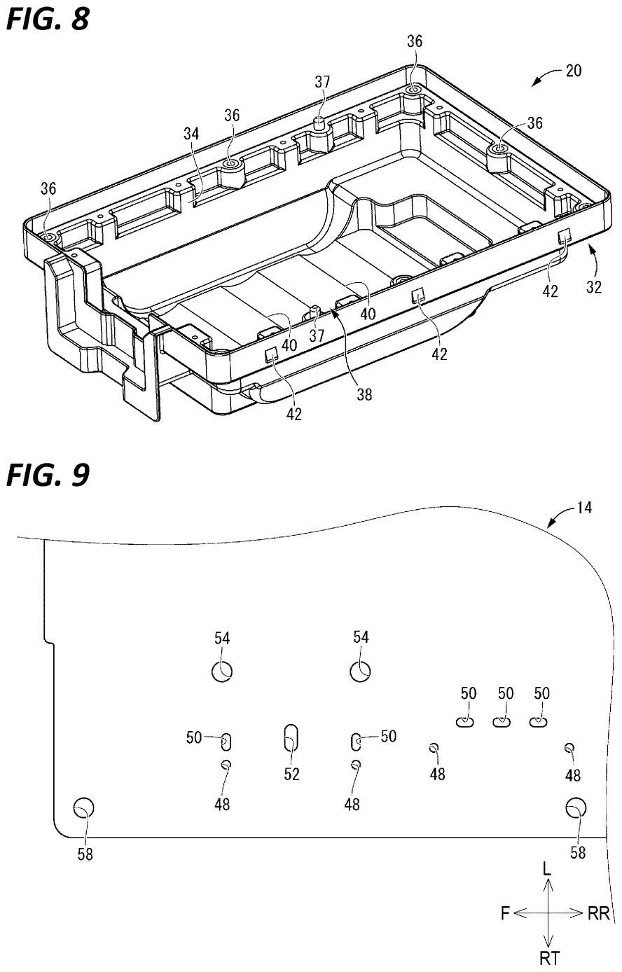

The upper case 20 includes an upper bottom wall portion 30 substantially rectangular in a plan view and an upper peripheral wall portion 32 projecting downward from an outer peripheral edge part of the upper bottom wall portion 30. A depth (vertical dimension from a lower opening) of the upper peripheral wall portion 32 is increased stepwise toward an inner peripheral side, i.e. the upper peripheral wall portion 32 spreads stepwise toward an outer peripheral side as extending downward. In this way, in the upper case 20, the upper bottom wall portion 30 is located at an uppermost position in a central part of the upper peripheral wall portion 32. Further, an upper contact portion 34 for contacting and supporting the printed circuit board 14 from above when the printed circuit board 14 is fixed in the case 12 by projecting downward is provided in an outer peripheral part of the upper peripheral wall portion 32. This upper contact portion 34 is substantially annularly provided over an entire periphery in a circumferential direction and, as shown in FIG. 8, screw holes 36, into which later-described screws 56 for fixing the printed circuit board 14 are screwed, are formed at a plurality of positions in the upper contact portion 34. Further, positioning pins 37 projecting downward are provided at positions deviated from the screw holes 36 in the circumferential direction in the upper contact portion 34, and the upper case 20 and the printed circuit board 14 are positioned relative to each other by these positioning pins 37 when the printed circuit board 14 is fixed.

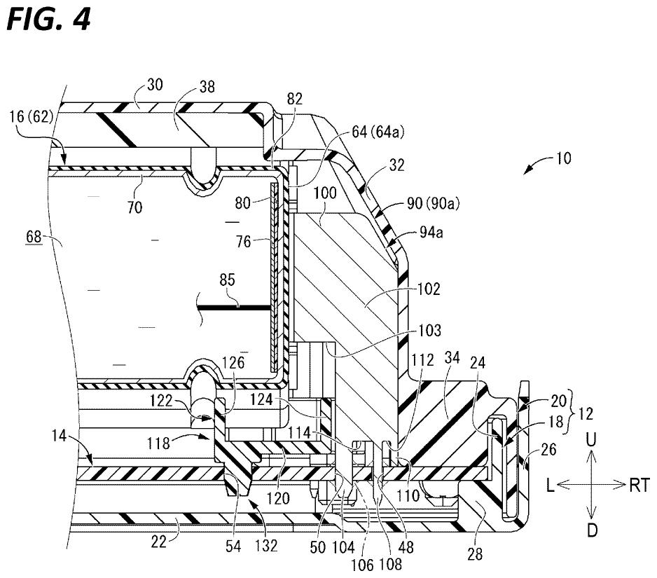

As also shown in FIGS. 4 to 6 and 8, an upper supporting portion 38 for supporting the respective capacitors 16 from above is provided on the lower surface of the upper bottom wall portion 30. The upper supporting portion 38 includes recesses 40 having curved surfaces corresponding to the outer peripheral surfaces of the respective capacitors 16 at positions corresponding to the respective capacitors 16. In this embodiment, three recesses 40 open downward are provided apart from each other in the front-rear direction. A curvature of each recess 40 is substantially equal to that of a tubular body 62 of each capacitor 16 to be described later and, in an assembled state of the power supply unit 10, the inner peripheral surface of each recess 40 is substantially entirely in contact with the outer peripheral surface of each tubular body 62. In this upper supporting portion 38, the number of the recesses 40 is changed, for example, according to the number of the capacitors 16. The upper supporting portion 38 can be formed separately from the upper case 20 and fixed to the lower surface of the upper bottom wall portion 30 later. The upper supporting portion 38 is, for example, made of synthetic resin. If the upper case 20 is made of metal, the upper supporting portion 38 can ensure insulation between the upper case 20 and each capacitor 16.

Further, engaging protrusions 42 projecting laterally outward are provided at positions corresponding to the respective engaging frame bodies 26 on the lower peripheral wall portion 24 on both left and right sides of the upper peripheral wall portion 32.

### Printed Circuit Board 14

The printed circuit board 14 is formed, such as by printing conductors of metal or the like on a rigid rectangular plate made of synthetic resin or the like, and an unillustrated circuit composed of the conductors is printed and formed on an upper surface and/or a lower surface with the printed circuit board 14 fixed in the case 12. A connector 44 is fixed on a front side on this printed circuit board 14 and electrically connected to the circuit on the printed circuit board 14. Note that an opening 46 penetrating in a thickness direction (front-rear direction) is formed in a front part of the case 12 (lower case 18 and upper case 20), and the connector 44 is exposed forward through the opening 46 of the case 12 when the power supply unit 10 is assembled.

Further, as also shown in FIGS. 4 and 9, with the printed circuit board 14 fixed in the case 12, through-holes 48, into which later-described connecting portions 108 of the respective capacitors 16 are inserted, are formed to penetrate in the plate thickness direction on both lateral sides of the printed circuit board 14. Furthermore, with the printed circuit board 14 fixed in the case 12, press-fitting holes 50, into which later-described press-fitting portions 104 of the respective capacitors 16 are press-fit, are formed to penetrate in the plate thickness direction on the both lateral sides of the printed circuit board 14. Each through-hole 48 is, for example, a substantially circular through hole and formed in such a size that the inner peripheral surface of the through-hole 48 and the outer peripheral surface of the connecting portion 108 do not contact each other when the connecting portion 108 is inserted. Each press-fitting hole 50 is, for example, a substantially circular through hole and inserted into the press-fitting hole 50 while the outer peripheral surface of the press-fitting portion 104 slides in contact with the inner peripheral surface of the press-fitting hole 50 when the press-fitting portion 104 is press-fit. In this embodiment, each press-fitting hole 50 is slightly smaller than the press-fitting portion 104 in either one of a front-rear dimension and a lateral direction and slightly larger than the press-fitting portion 104 in the other dimension. Solder wicking to be described later is also possible while press-fitting as described above is realized.

These respective through-holes 48 and press-fitting holes 50 are formed at positions corresponding to the respective connecting portions 108 and press-fitting portions 104 in the respective capacitors 16. Specifically, as also shown in FIG. 9, a pair of the press-fitting holes 50, 50 are provided apart from each other in the front-rear direction and a pair of the through-holes 48, 48 are provided apart from each other in the front-rear direction in a part where the negative electrode 66a of each capacitor 16 to be described later is held on the printed circuit board 14. These respective through-holes 48 and press-fitting holes 50 are provided apart from each other in the lateral direction, and the respective through-holes 48 are provided outwardly of the respective press-fitting holes 50 in the lateral direction. Further, three press-fitting holes 50 are provided apart from each other in the front-rear direction and a pair of the through-holes 48, 48 are provided apart from each other in the front-rear direction in a part where the positive electrode 66b of each capacitor 16 to be described later is held. This pair of through-holes 48, 48 are provided on both sides in the front-rear direction and laterally outwardly of the respective three press-fitting holes 50.

As described later, electrolyte containers 118 are arranged in the parts where the negative electrodes 66a of the respective capacitors 16 are held on the printed circuit board 14. That is, press-fitting holes 52, into which press-fitting leg portions 130 of the electrolyte containers 118 are press-fit, and fitting holes 54, into which fitting leg portions 132 of the electrolyte container 118 are inserted and fit, are formed to penetrate through the printed circuit board 14 in the plate thickness direction. In this embodiment, one electrolyte container 118 is formed with one press-fitting leg portion 130 and a pair of the fitting leg portions 132, 132, and the printed circuit board 14 is formed with one press-fitting hole 52 and a pair of the fitting holes 54, 54 at positions corresponding to the respective leg portions. Specifically, the press-fitting hole 52 is provided in a center in the front-rear direction between the pair of press-fitting holes 50, 50, and the pair of fitting holes 54, 54 are provided laterally inwardly of the pair of press-fitting holes 50, 50.

Further, in this embodiment, the printed circuit board 14 is fixed to the upper case 20 by the screws 56, and screw holes 58, into which the respective screws 56 are inserted, are formed to penetrate in the plate thickness direction at a plurality of positions of an outer peripheral part of the printed circuit board 14. Furthermore, in the printed circuit board 14, positioning holes 60, into which the respective positioning pins 37 are inserted, are formed to penetrate in the plate thickness direction at positions corresponding to the respective positioning pins 37 in the upper case 20. Note that each positioning pin 37 may be press-fit into each positioning hole 60 or may be loosely inserted thereinto.

### Capacitors 16

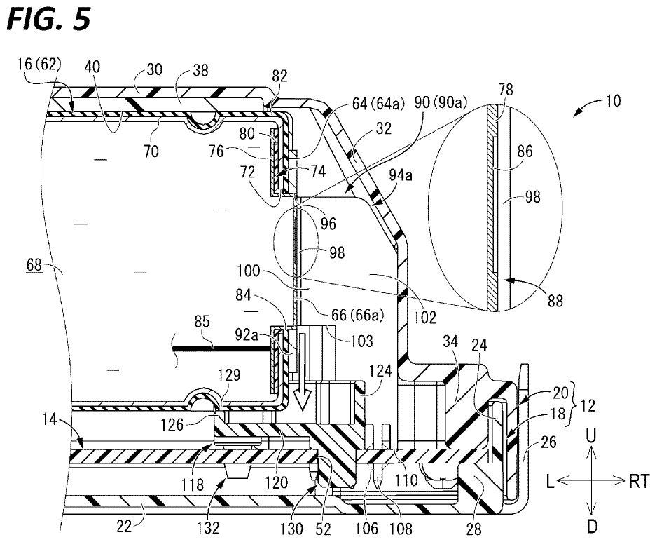

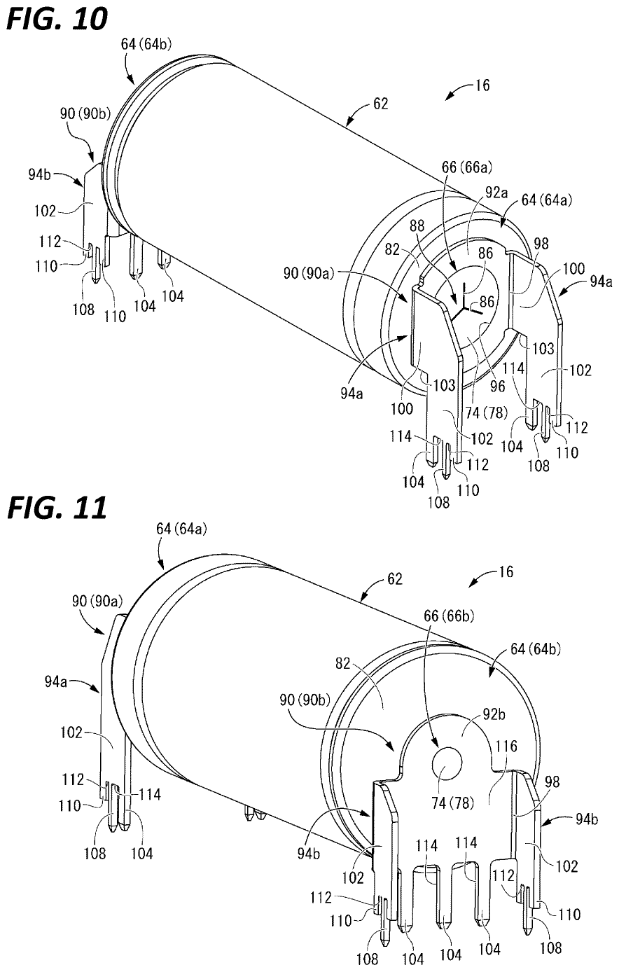

As also shown in FIGS. 10 and 11, the capacitor 16 is a capacitor of a so-called axial type and includes a pair of the electrodes 66, 66 (negative electrode 66a, positive electrode 66b) on both end surfaces 64, 64 (one end surface 64a and other end surface 64b) in an axial direction of the tubular body 62. Further, the side of the one end surface 64a (negative electrode 66a) in the capacitor 16 is shown in FIGS. 4 and 5. A specific structure inside the capacitor 16 is not limited, but the capacitor 16 is assumed as an electric double layer capacitor (EDLC) having an electrolyte 68 enclosed inside in this embodiment.

More particularly, the capacitor 16 includes a substantially hollow cylindrical capacitor case 70 as shown in FIGS. 4 to 6. The capacitor case 70 is made of metal and both end parts in the axial direction are bent toward an inner peripheral side. In this way, a circuit through hole 72 penetrating in a thickness direction (center axis direction of the capacitor 16 and lateral direction) is formed in a central part in each of both axial end parts of the capacitor case 70. This through-hole 72 is covered from inside by a terminal plate 74 made of metal. The terminal plate 74 has a substantially disk shape as a whole and an inner peripheral part thereof projects toward one side in the plate thickness direction with respect to an outer peripheral part. That is, the terminal plate 74 includes a substantially annular flange-like portion 76 in the outer peripheral part and a projecting portion 78 projecting toward one side in the plate thickness direction with respect to the flange-like portion 76 in the inner peripheral part.

This terminal plate 74 is overlapped on the axial end part of the capacitor case 70 from inside in the axial direction. In this way, the part bent toward the inner peripheral side in the axial end part of the capacitor case 70 is overlapped on the flange-like portion 76, which is an outer peripheral part of the terminal plate 74, and the projecting portion 78 projects outwardly of the capacitor case 70 in the axial direction through the through hole 72. Note that the part bent toward the inner peripheral side in the axial end part of the capacitor case 70 and the flange-like portion 76 of the terminal plate 74 are overlapped in a liquid-tight manner via a substantially annular insulation layer 80 made of rubber, synthetic resin or the like. In this way, the capacitor case 70 and the terminal plate 74 are electrically insulated, and the leakage of the electrolyte 68 through between the capacitor case 70 and the terminal plate 74 is prevented.

Further, in the capacitor case 70, at least both axial end surfaces are covered by covering rubber layers 82, and the one end surface 64a and the other end surface 64b in the axial direction in the capacitor 16 are constituted by these covering rubber layers 82. Note that the covering rubber layer 82 may be, for example, provided to entirely cover the outer surfaces of the capacitor case 70 including the both axial end surfaces. Insertion holes 84 penetrating in the thickness direction (center axis direction of the capacitor 16 and lateral direction) are formed in central parts of the one end surface 64a and the other end surface 64b in the axial direction of these covering rubber layers 82. The projecting portion 78 projecting axially outward from the capacitor case 70 is inserted into this insertion hole 84, and projects further axially outward than the covering rubber layer 82. In short, the through hole 72 and the insertion hole 84 of the covering rubber layer 82 are positioned to communicate in each of the both axial end parts of the capacitor case 70, and the projecting portion 78 of each terminal plate 74 projects axially outward and is exposed to outside through these through hole 72 and insertion hole 84.

Here, although not shown, an activated carbon electrode constituting a positive electrode and an activated carbon electrode constituting a negative electrode are overlapped via a separator and these activated carbon electrodes constituting the positive and negative electrodes and the separator are spirally wound inside the capacitor 16. A lead wire 85 extends from the activated carbon electrode constituting the negative electrode and is connected to the terminal plate 74 on the side of the one axial end surface 64a in the capacitor 16. In this way, the terminal plate 74 has negative electric charges and the negative electrode 66a is constituted by the projecting portion 78 exposed to outside on the one axial end surface 64a in the capacitor 16. Further, an unillustrated lead wire extends from the activated carbon electrode constituting the positive electrode and is connected to the terminal plate 74 on the side of the other axial end surface 64b in the capacitor 16. In this way, the terminal plate 74 has positive electric charges and the positive electrode 66b is constituted by the projecting portion 78 exposed to outside on the other axial end surface 64b in the capacitor 16.

These negative and positive electrodes 66a, 66b (in short, the projecting portions 78 on the both terminal plates 74) have both a circular shape when viewed from the axial direction of the capacitor 16 (when viewed from the lateral direction). The sizes of the negative and positive electrodes 66a, 66b are not limited, but the negative electrode 66a has a larger circular shape than the positive electrode 66b when viewed from the axial direction of the capacitor 16 (when viewed from the lateral direction) in this embodiment. As also shown in FIGS. 3 and 5, elongated groove portions 86 are provided in a central part of the position electrode 66a. These groove portions 86 have such a depth as not to extend over the entire length in the thickness direction of the projecting portion 78 in the terminal plate 74, and the negative electrode 66a is thinned at the formation positions of the groove portions 86. That is, the groove portions 86 do not penetrate through the negative electrode 66a and the leakage of the electrolyte 68 through the groove portions 86 is prevented when the capacitor 16 is in a normal state.

In this embodiment, a plurality of (three) groove portions 86 are provided, and each groove portion 86 extends toward an outer peripheral side from a center of the negative electrode 66a. Particularly, in this embodiment, the three groove portions 86 are provided substantially at equal intervals (at every 120°) in a circumferential direction. In this way, the strength of the negative electrode 66a is reduced particularly in the central part, and the central part of the negative electrode 66a is preferentially broken when a gas is generated inside and an internal pressure increases when the capacitor 16 is in an abnormal state. As a result, an internal space and an external space of the capacitor 16 communicate with each other and the gas inside is allowed to escape. The negative electrode 66a is provided with a gas exhaust valve 88 for discharging the gas generated in the abnormal state. Thus, the gas exhaust valve 88 is configured to include the respective groove portions 86. Note that thicknesses of the respective projecting portions 78 constituting the negative and positive electrodes 66a, 66b are not limited. However, by forming the negative electrode 66a thinner than the positive electrode 66b, the central part of the negative electrode 66a is more preferentially broken to set the gas exhaust valve 88 in an open state when the capacitor 16 is in an abnormal state.

### Metal Flat Plates 90

A metal flat plate 90 is electrically conductively fixed to each of the electrodes 66. That is, a negative flat plate 90a constituting the metal flat plate 90 is fixed to the negative electrode 66a as shown in FIG. 10, and a positive flat plate 90b constituting the metal flat plate 90 is fixed to the positive electrode 66b as shown in FIG. 11. These negative and positive flat plates 90a, 90b are, for example, made of aluminum (including aluminum alloy) or copper (including copper alloy) excellent in electrical conductivity. In this embodiment, each of the negative and positive flat plates 90a, 90b is formed by bending a metal base plate having a substantially rectangular shape as a whole into a predetermined shape. A length direction of each of these negative and positive flat plates 90a, 90b is a longitudinal direction of the metal base plate before being bent, and the front-rear direction, which is one direction orthogonal to the center axis direction (lateral direction) of the capacitor 16 with the respective negative and positive flat plates 90a, 90b fixed to the negative and positive electrodes 66a, 66b.

### Negative Flat Plate 90a

In the negative flat plate 90a, a central part in the length direction (front-rear direction) constitutes a welded portion 92a to be overlapped on and welded to the electrode 66 (negative electrode 66a). Further, in the negative flat plate 90a, both side parts in the length direction constitute a pair of projecting plate portions 94a, 94a bent in a plate thickness direction (lateral direction) and projecting outward in the axial direction of the tubular body 62. Therefore, the pair of projecting plate portions 94a, 94a spread in the lateral direction and are provided apart from each other in the front-rear direction.

Specifically, as shown in FIGS. 3 and 10, the welded portion 92a in the negative flat plate 90a has a substantially annular shape and is externally fit to the negative electrode 66a projecting axially outward in the capacitor 16. That is, a circular through hole 96 penetrating in the plate thickness direction (lateral direction) is formed in a central part of the welded portion 92a, and the outer peripheral surface of the negative electrode 66a and the inner peripheral surface of the through hole 96 are overlapped in a radial direction. The surfaces overlapping each other in the radial direction are welded, whereby the negative flat plate 90a and the negative electrode 66a are fixed to each other. Note that the welded portion 92a in the negative flat plate 90a may be axially overlapped on the covering rubber layer 82 located axially inward or, instead of or in addition to welding to the negative electrode 66a, the negative flat plate 90a and the covering rubber layer 82 may be bonded. In this embodiment, the welded portion 92a in the negative flat plate 90a is arranged around the gas exhaust valve 88 provided in the negative electrode 66a.

Further, in the metal base plate constituting the negative flat plate 90a, parts on both sides in the length direction of the welded portion 92a having a substantially circular shape are bent axially outward, whereby the respective projecting plate portions 94a are formed. That is, the respective projecting plate portions 94a are connected to both end parts in the front-rear direction of the welded portion 92a via concavely bent parts, and these concavely bent parts extend in the vertical direction, i.e. extend toward the printed circuit board on a lower side. Guiding grooves 98 for guiding the electrolyte 68 during the leakage of the electrolyte 68 from the gas exhaust valve 88 when the capacitor 16 is in an abnormal state as described later are constituted by the concavely bent parts extending toward the printed circuit board 14. In other words, the guiding grooves 98, 98 extending toward the printed circuit board 14 are constituted by a pair of the concavely bent parts coupling the metal flat plate 90 (negative flat plate 90a) and the pair of projecting plate portions 94a, 94a.

In this embodiment, the respective projecting plate portions 94a in the negative flat plate 90a have the same shape and respectively have a substantially rectangular shape. Specifically, each projecting plate portion 94a in the negative flat plate 90a includes an extending portion 100 extending axially outward from one of both end parts in the front-rear direction of the welded portion 92a via the concavely bent part (guiding groove 98) and a downward projecting portion 102 projecting downward from an extending end part (axially outer end part) of the extending portion 100. Therefore, the guiding groove 98 is formed in a part of each extending portion 100 connected to the end part in the front-rear direction of the welded portion 92a.

That is, each downward projecting portion 102 is not directly connected to the end part in the front-rear direction of the welded portion 92a, but connected thereto via the extending portion 100, and each downward projecting portion 102 and the end part in the front-rear direction of the welded portion 92a are separated from each other in the axial direction of the welded portion 92a (lateral direction). In other words, in the case of assuming such projecting plate portions that downward projecting portions are directly connected to the both end parts in the front-rear direction of the welded portion 92a, a cut portion 103 open downward is provided in an inner part in the front-rear direction of the projecting plate portion, whereby the downward projecting portion 102 separated from the extending portion 100 and the welded portion 92a is formed in each projecting plate portion 94a. Further, each downward projecting portion 102 is provided with the connecting portion 108 as described later. Therefore, each projecting plate portion 94a is provided with the connecting portion 108 and the cut portion 103, and the guiding groove 98 and the connecting portion 108 are separated in the axial direction (lateral direction) by the cut portion 103.

The press-fitting portion 104 to be press-fit into the press-fitting hole 50 in the printed circuit board 14 and the connecting portion 108 to be inserted into the through-hole 48 of the printed circuit board 14 and electrically connected to the through-hole 48 by solder 106 (shown by a two-dot chain line in FIGS. 4 to 6) are provided in the lower end of each downward projecting portion 102. Further, a stopper portion 110 for specifying an insertion amount of the connecting portion 108 into the through-hole 48 by being placed on the printed circuit board 14 is provided in the lower end of each downward projecting portion 102. By press-fitting each press-fitting portion 104 into each press-fitting hole 50, each capacitor 16 is fixedly held on the printed circuit board 14. Note that, in this embodiment, each press-fitting portion 104 press-fit into each press-fitting hole 50 is also soldered, so that each capacitor 16 is more firmly held on the printed circuit board 14. Cross-sectional shapes of these press-fitting portions 104, connecting portions 108 and stopper portions 110 are not limited, but any of the press-fitting portions 104, the connecting portions 108 and the stopper portions 110 has a substantially rectangular cross-sectional shape in this embodiment.

Further, in this embodiment, each of the projecting plate portions 94a separated from each other in the front-rear direction is provided with the press-fitting portion 104, the connecting portion 108 and the stopper portion 110. Thus, in the negative flat plate 90a, a pair of the press-fitting portions 104, 104 are provided apart from each other in the front-rear direction, a pair of the connecting portions 108, 108 are provided apart from each other in the front-rear direction, and the pair of press-fitting portions 104, 104 and the pair of connecting portions 108, 108 are all provided to project downward toward the printed circuit board 14. Further, in the negative flat plate 90a, a pair of the stopper portions 110, 110 are separated from each other in the front-rear direction and provided to project downward toward the printed circuit board 14.

In the lower end of each downward projecting portion 102, the press-fitting portion 104, the connecting portion 108 and the stopper portion 110 are separated from each other in a plate width direction (lateral direction) of the downward projecting portion 102. An arrangement mode of the press-fitting portion 104, the connecting portion 108 and the stopper portion 110 in the lower end of each downward projecting portion 102 is not limited, but the press-fitting portion 104 is provided on a laterally inner end part of each downward projecting portion 102. Further, the stopper portion 110 is provided on a laterally outer end part of each downward projecting portion 102, and the connecting portion 108 is provided apart from the press-fitting portion 104 and the stopper portion 110 in a lateral intermediate part of each downward projecting portion 102.

As shown in FIGS. 4 and 5, a part between the stopper portion 110 and the connecting portion 108 in the lower end of each downward projecting portion 102 is separated upward from the printed circuit board 14 with each stopper portion 110 placed on the printed circuit board 14. Further, with each stopper portion 110 placed on the printed circuit board 14, a part between the connecting portion 108 and the press-fitting portion 104 in the lower end of each downward projecting portion 102 is separated upward from the printed circuit board 14. That is, with each stopper portion 110 placed on the printed circuit board 14, a gap 112 spreading upward is formed around each connecting portion 108. The gap 112 is, for example, a gap between the connecting portion 108 and the stopper portion 110 arranged in the lateral direction. Further, with each stopper portion 110 placed on the printed circuit board 14, a gap 114 spreading upward is formed around each press-fitting portion 104. The gap 114 is, for example, a gap between the connecting portion 108 and the press-fitting portion 104 arranged in the lateral direction.

### Positive Flat Plate 90b

The structure of the positive flat plate 90b is basically similar to that of the negative flat plate 90a, and a central part in a length direction (front-rear direction) constitutes a welded portion 92b to be overlapped on and welded to the electrode 66 (positive electrode 66b). Further, in the positive flat plate 90b, both side parts in the length direction constitute a pair of projecting plate portions 94b, 94b bent in a plate thickness direction (lateral direction) and projecting outward in the axial direction of the tubular body 62. Therefore, the pair of projecting plate portions 94b, 94b spread in the lateral direction and are provided apart from each other in the front-rear direction.

Specifically, as also shown in FIGS. 3 and 11, the welded portion 92b in the positive flat plate 90b has a substantially annular shape similarly to the negative flat plate 90a and is externally fit to the positive electrode 66b projecting axially outward in the capacitor 16. That is, a circular through hole 96 penetrating in the plate thickness direction (lateral direction) is also formed in a central part of the welded portion 92b, and the outer peripheral surface of the positive electrode 66b and the inner peripheral surface of the through hole 96 are overlapped in a radial direction. The surfaces overlapping each other in the radial direction are welded, whereby the positive flat plate 90b and the positive electrode 66b are fixed to each other. Note that the welded portion 92b in the positive flat plate 90b may also be axially overlapped on the covering rubber layer 82 located axially inward or, instead of or in addition to welding to the positive electrode 66b, the positive flat plate 90b and the covering rubber layer 82 may be bonded.

Further, in the metal base plate constituting the positive flat plate 90b, a part having a substantially rectangular shape is provided to be continuous with the welded portion 92b having a substantially annular shape, and both end parts in the length direction of this part having a substantially rectangular shape are bent axially outward, whereby the respective projecting plate portions 94b are formed. That is, an intermediate part in the length direction of the part having a substantially rectangular shape continuously spreads from the welded portion 92b without being bent and constitutes an intermediate plate portion 116. With the positive flat plate 90b fixed to the positive electrode 66b, the intermediate plate portion 116 is provided to project downward from the welded portion 92b and the respective projecting plate portions 94b are connected to both end parts in the front-rear direction of the intermediate plate portion 116 via concavely bent parts.

The press-fitting portions 104 to be press-fit into the press-fitting holes 50 in the printed circuit board 14 are provided in a lower end part of this intermediate plate portion 116. In this embodiment, three press-fitting portions 104 are provided in the lower end part of the intermediate plate portion 116 and the respective press-fitting portions 114 are provided to project downward toward the printed circuit board 14 while being separated from each other in a plate width direction (front-rear direction) of the intermediate plate portion 116.

Further, in this embodiment, the respective projecting plate portions 94b in the positive flat plate 90b also have the same shape and respectively have a substantially rectangular shape. Note that each projecting plate portion 94b in the positive flat plate 90b does not include the extending portion 100 (cut portion 103) unlike each projecting plate portion 94a in the negative flat plate 90a, and downward projecting portions 102 are connected to both end parts in the front-rear direction of the intermediate plate portion 116 via the concavely bent parts. That is, in the positive flat plate 90b, the respective projecting plate portions 94b are constituted by the respective downward projecting portions 102.

The connecting portion 108 to be inserted into the through-hole 48 in the printed circuit board 14 and electrically connected to the through-hole 48 by the solder 106 is provided in the lower end of the downward projecting portion 102 in the positive flat plate 90b. Further, stopper portions 110 for specifying an insertion amount of each connecting portion 108 into the through-hole 48 by being placed on the printed circuit board 14 are provided in the lower end of each downward projecting portion 102. Also in the positive flat plate 90b, any of these press-fitting portions 104, connecting portions 108 and stopper portions 110 has a substantially rectangular cross-sectional shape. Since the respective projecting plate portions 94b are separated from each other in the front-rear direction, the respective connecting portions 108 and the respective stopper portions 110 provided in the respective projecting plate portions 94b are also separated from each other in the front-rear direction and provided to project downward toward the printed circuit board 14.

An arrangement mode of the connecting portion 108 and the stopper portions 110 in the lower end of each downward projecting portion 102 is not limited, but the stopper portions 110 are provided in both lateral end parts of each downward projecting portion 102. Further, the connecting portion 108 is provided apart from the respective stopper portions 110 on both sides in a lateral intermediate part of each downward projecting portion 102.

Also in the positive flat plate 90b, parts between the respective press-fitting portions 104 in the lower end of the intermediate plate portion 116 are separated upward from the printed circuit board 14 with each stopper portion 110 placed on the printed circuit board 14. Further, with each stopper portion 110 placed on the printed circuit board 14, parts between the respective stopper portions 110 and the connecting portion 108 in the lower end of each downward projecting portion 102 are separated upward from the printed circuit board 14. That is, also in the positive flat plate 90b, a gap 112 spreading upward is formed around each connecting portion 108 with each stopper portion 110 placed on the printed circuit board 14. The gap 112 is, for example, a gap between the connecting portion 108 and the stopper portion 110 arranged in the lateral direction. Further, with each stopper portion 110 placed on the printed circuit board 14, a gap 114 spreading upward is formed around each press-fitting portion 104. The gap 114 is, for example, a gap between the press-fitting portions 104 arranged in the lateral direction.

### Electrolyte Container 118

The electrolyte container 118 located below the gas exhaust valve 88 and the respective guiding grooves 98 and configured to store the electrolyte 68 oozing out from the gas exhaust valve 88 is arranged on the printed circuit board 14. That is, the electrolyte container 118 is provided on the side of the one end surface 64a (negative electrode 66a) in the capacitor 16 on the printed circuit board 14. In this embodiment, since three capacitors 16 are provided, three electrically containers 118 are provided. Particularly, in this embodiment, the negative electrode 66a and the positive electrode 66b of the middle capacitor 16, out of the three capacitors 16, are provided on the sides opposite to those of the capacitors 16, 16 on the both sides. Thus, the middle electrolyte container 118 is provided on a side opposite to the electrolyte containers 118, 118 on both sides in the lateral direction. In this way, even if the electrolyte containers have, for example, a laterally long shape with a front-rear dimension larger than a lateral dimension, the interference of the adjacent electrolyte containers can be avoided.

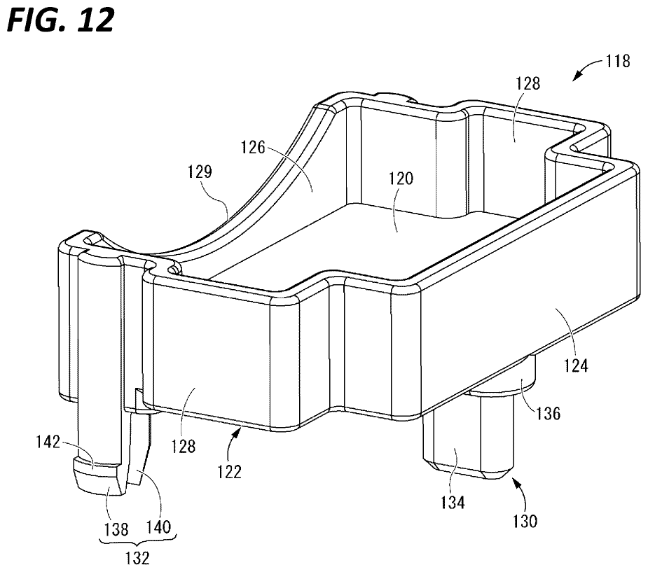

As shown in FIG. 12, the electrolyte container 118 is in the form of a substantially rectangular box open upward as a whole and, for example, made of synthetic resin. The electrolyte container 118 includes a bottom wall 120 and a peripheral wall 122 projecting upward from an outer peripheral edge part of the bottom wall 120. This peripheral wall 122 includes an outer wall portion 124 located outside the capacitor 16 in the axial direction (lateral direction), an inner wall portion 126 located inside the capacitor 16 in the axial direction and a pair of side wall portions 128, 128 connecting these outer wall portion 124 and inner wall portion 126 with the capacitor 16 and the electrolyte container 118 mounted on the printed circuit board 14. That is, the pair of side wall portions 128, 128 are facing each other across a predetermined distance in the front-rear direction.

Further, a recess 129 for avoiding interference with the tubular body 62 of the capacitor 16 is formed in an upper end part of the inner wall portion 126. In this embodiment, the recess 129 has a curved shape corresponding to the outer peripheral surface of the tubular body 62, but may be a rectangular recess. Further, in this embodiment, a curvature of the inner peripheral surface (upper end surface) of the recess 129 is substantially equal to that of the outer peripheral surface of the tubular body 62, and the inner peripheral surface of each recess 129 contacts the substantially entire outer peripheral surface of each tubular body 62 when each capacitor 16 and each electrolyte container 118 are mounted on the printed circuit board 14 as described later. Note that the curvature of the inner peripheral surface of the recess may be, for example, smaller than that of the outer peripheral surface of the tubular body 62. Further, the inner peripheral surface of each recess 129 may not contact the outer peripheral surface of each tubular body 62 when each capacitor 16 and each electrolyte container 118 are mounted on the printed circuit board 14 or such a recess 129 may not be provided.

The press-fitting leg portions 130 to be press-fit into the press-fitting holes 52 in the printed circuit board 14 are provided in a center in the front-rear direction and on laterally outer end parts on the lower surface of the bottom wall 120. Further, the fitting leg portions 132 to be inserted and fit into the fitting holes 54 in the printed circuit board 14 are provided on both end parts in the front-rear direction and laterally inner end parts on the lower surface of the bottom wall 120.

Specifically, a lower part of the press-fitting leg portion 130 is an inserting portion 134 to be press-fit and inserted into the press-fitting hole 52, and an upper part of the press-fitting leg portion 130 is a large-diameter portion 136 having a larger shape than the press-fitting hole 52. In press-fitting the press-fitting leg portion 130 into the press-fitting hole 52, the inserting portion 134 is press-fit and inserted into the press-fitting hole 152 and the large-diameter portion 136 contacts a part around the press-fitting hole 52 on the upper surface of the printed circuit board 14, whereby any further press-fitting of the press-fitting leg portion 130 into the press-fitting hole 52 is limited.

Further, each fitting leg portion 132 includes an outer side portion 138 and an inner side portion 140 facing each other across a predetermined distance in the front-rear direction, and these outer side portion 138 and inner side portion 140 are resiliently deformable in directions toward or away from each other. A lower end part of each outer side portion 138 is provided with a locking claw 142 projecting outward in the front-rear direction. Each fitting leg portion 132 is insertable into each fitting hole 54 with the outer side portion 138 and the inner side portion 140 held close to each other. Further, by passing the locking claw 142 of each outer side portion 138 through the fitting hole 54, the outer side portion 138 and the inner side portion 140 are resiliently restored into an initial state and each locking claw 142 is locked to the part around the fitting hole 54 in the lower surface of the printed circuit board 14, whereby each fitting leg portion 132 is prevented from coming out from the fitting hole 54.

### Assembly Process of Power Supply Unit 10

Next, an example of an assembly process of the power supply unit 10 is described. Note that the assembly process of the power supply unit 10 is not limited to the one described below.

First, the connector 44 is arranged on the printed circuit board 14, and the circuit on the printed circuit board 14 and the connector 44 are electrically connected. Further, each press-fitting leg portion 130 of each electrolyte container 118 is press-fit into each press-fitting hole 52 in the printed circuit board 14 and each fitting leg portion 132 is inserted and fit into each fitting hole 54. In this way, the three electrolyte containers 118 are fixed to the printed circuit board 14.

Thereafter, each press-fitting portion 104 of each capacitor 16 is press-fit into each press-fitting hole 50 in the printed circuit board 14 and each connecting portion 108 is inserted into each through-hole 48. Each press-fitting portion 104 is press-fit and each connecting portion 108 is inserted until each stopper portion 110 of each capacitor 16 contacts and is placed on the upper surface of the printed circuit board 14. By press-fitting each press-fitting portion 104 into each press-fitting hole 50, each capacitor 16 is fixedly held on the printed circuit board 14. Subsequently, the solder 106 is injected into between each press-fitting hole 50 and each press-fitting portion 104 and between each through-hole 48 and each connecting portion 108, whereby each press-fitting hole 50 and each press-fitting portion 104 are soldered and each through-hole 48 and each connecting portion 108 are soldered. Note that a conventionally known soldering step such as reflow soldering can be adopted as this soldering step.

Subsequently, the printed circuit board 14 mounted with the connector 44, each electrolyte container 118 and each capacitor 16 as described above is fixed to the upper case 20 by the screws 56. At that time, the vertically inverted printed circuit board 14 may be overlapped on the opening of the upper case 20 similarly vertically inverted to be open upward, and screwed from above.

Thereafter, the lower case 18 is brought closer to the upper case 20 having the printed circuit board 14 fixed thereto and each engaging protrusion 42 of the upper case 20 is engaged with each engaging frame body 26 of the lower case 18, whereby the upper case 20 and the lower case 18 are fixed. In this way, the power supply unit 10 is completed.

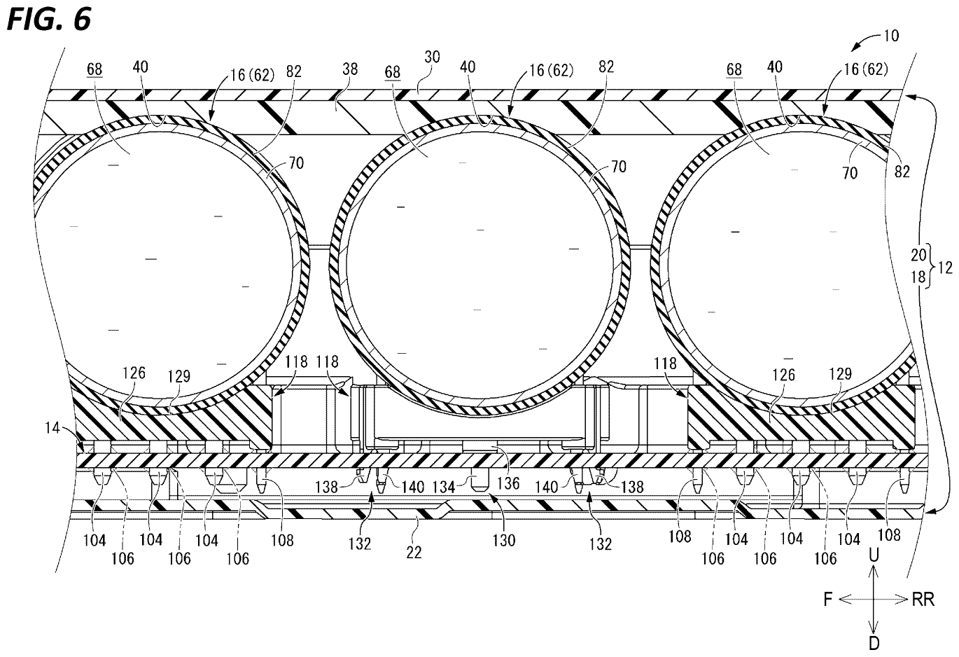

In the power supply unit 10 assembled by the process as described above, an outer peripheral part of the printed circuit board 14 is supported by being sandwiched in the vertical direction by the upper contact portion 34 of the upper case 20 and the lower contact portion 28 of the lower case 18 as shown in FIGS. 4 and 5. Further, as shown in FIGS. 5 and 6, the end part of each capacitor 16 on the side of the one axial end surface 64a (negative electrode 66a) is inserted into the recess 129 provided in the inner wall portion 126 of each electrolyte container 118, and the inner peripheral surface of each recess 129 and the outer peripheral surface of each tubular body 62 are held in contact over a predetermined circumferential dimension. In this way, each capacitor 16 is sandwiched in the vertical direction also by each recess 129 in each electrolyte container 118 and each recess 40 of the upper supporting portion 38 provided in the upper case 20. Therefore, each capacitor 16 is fixedly held on the printed circuit board 14 also by the case 12 (upper case 20 and lower case 18).

According to the power supply unit 10 of this embodiment, the negative flat plate 90a and the positive flat plate 90b are respectively fixed to the negative electrode 66a and the positive electrode 66b of each capacitor 16, and each of these negative flat plate 90a and positive flat plate 90b includes the press-fitting portions 104. By press-fitting each press-fitting portion 104 into each press-fitting hole 50 of the printed circuit board 14, each capacitor 16 is fixedly held on the printed circuit board 14. Particularly, the negative flat plate 90a includes the downward projecting portions 102 projecting downward, the positive flat plate 90b includes the intermediate plate portion 116 projecting downward, and the respective press-fitting portions 104 are provided in the lower ends of these downward projecting portions 102 and intermediate plate portion 116. In this way, each capacitor 16 is held in a state separated upward from the printed circuit board 14, and each capacitor 16 can be fixed to the printed circuit board 14 and each capacitor case 70 and the printed circuit board 14 can be electrically insulated without requiring a holder or the like made of synthetic resin.

Particularly, since each of the negative flat plate 90a and the positive flat plate 90b includes the press-fitting portions 104 in this embodiment, each capacitor 16 can be fixed to the printed circuit board 14 by the respective press-fitting portions 104 on the both sides in the axial direction. In this way, it is possible to reduce a possibility that an unfixed end part of a capacitor is shaken by the vibration or the like of a vehicle, for example, when only one axial side of the capacitor is fixed to a printed circuit board, and it is possible to stably fix each capacitor 16 to the printed circuit board 14.

Each of the negative flat plate 90a and the positive flat plate 90b includes the stopper portions 110, and the gap 112 spreading upward is formed around each connecting portion 108 with each stopper portion 110 placed on the printed circuit board 14. Similarly, the gap 114 spreading upward is formed around each press-fitting portion 104 with each stopper portion 110 placed on the printed circuit board 14. In this way, solder wicking can be promoted when each connecting portion 108 and each press-fitting portion 104 are soldered to the printed circuit board 14, and solder wicking can be visually confirmed from outside after the soldering step.

The negative flat plate 90a includes the welded portion 92a in the central part in the length direction and the respective projecting plate portions 94a, 94a projecting axially outwardly of the tubular body 62 in the both side parts in the length direction. That is, the negative flat plate 90a includes the pair of projecting plate portions 94a, 94a separated from each other in the front-rear direction, and each projecting plate portion 94a includes the press-fitting portion 104. Accordingly, since each capacitor 16 is supported on the printed circuit board 14 at two points separated from each other in the front-rear direction by the respective press-fitting portions 104 on the side of the negative electrode 66a in each capacitor 16, a holding force for each capacitor 16 on the printed circuit board 14 can be improved. Particularly, the positive flat plate 90b includes the respective press-fitting portions 104 in the central part in the length direction. In this way, in vertical projection, each capacitor 16 is held on the printed circuit board 14 at three points separated from each other in the front-rear direction and the lateral direction, and the holding force is further improved.

Further, the positive flat plate 90b includes the welded portion 92b in the central part in the length direction and the respective projecting plate portions 94b, 94b projecting axially outwardly of the tubular body 62 in the both side parts in the length direction. In both the negative flat plate 90a and the positive flat plate 90b, each of the projecting plate portions 94a, 94b includes the stopper portion(s) 110. In this way, the respective stopper portions 110 are placed on the printed circuit board 14 at four positions separated in the lateral direction and the front-rear direction, wherefore a possibility of holding each capacitor 16 obliquely with respect to the printed circuit board 14 can be reduced. Particularly, each connecting portion 108 is provided near each stopper portion 110 in both the negative flat plate 90a and the positive flat plate 90b. In this way, each connecting portion 108 can be prevented from being obliquely inserted into each through-hole 48 and each connecting portion 108 and the printed circuit board 14 can be stably electrically connected.

The gas exhaust valve 88 for discharging the gas generated when each capacitor 16 is in an abnormal state is provided in the one axial end surface 64a (negative electrode 66a) of each capacitor 16. In this way, the breakage of each capacitor 16 by the gas at time of abnormality is avoided. Here, since the gas exhaust valve 88 is opened when the gas is discharged, the electrolyte 68 may ooze out through the gas exhaust valve 88. The electrolyte 68 oozing out through the gas exhaust valve 88 leaks along the negative flat plate 90a, but the negative flat plate 90a is provided with the guiding grooves 98 for guiding the electrolyte 68 and these guiding grooves 98 are provided apart from the connecting portions 108 in the axial direction of the capacitor 16 (lateral direction) by providing the cut portions 103 in the respective projecting plate portions 94a. Therefore, the electrolyte 68 is guided to positions different from the connecting portions 108 by flowing along the respective guiding grooves 98 in the negative flat plate 90a, and a failure such as a conduction failure of electrically connected parts of the negative flat plate 90a and the printed circuit board 14 (connecting portions 108) caused by the leaked electrolyte 68 can be avoided.

Particularly, in this embodiment, the electrolyte container 118 located below the gas exhaust valve 88 and the respective guiding grooves 98 and configured to store the electrolyte 68 oozing out from the gas exhaust valve 88 is provided on the printed circuit board 14. Thus, as indicated by white arrows in FIGS. 3 and 5, both the electrolyte 68 leaking out directly downward from the gas exhaust valve 88 and the electrolyte 68 flowing along the respective guiding grooves 98 are received by the electrolyte container 118 and prevented from flowing out onto the printed circuit board 14. As a result, it is also possible to avoid failures such as the occurrence of a conduction failure caused by the leaked electrolyte 68 flowing on the printed circuit board 14 and reaching the connecting portions 108.

### Modifications

Although the embodiment has been described in detail as a specific example of the present disclosure, the present disclosure is not limited by this specific description. Modifications, improvements and the like within a range that the aim of the present disclosure can be achieved are included in the present disclosure. For example, the following modifications of the embodiment are also included in the technical scope of the present disclosure.

(1) Although the negative flat plate 90a is provided with the respective press-fitting portions 104 and the positive flat plate 90b is also provided with the respective press-fitting portions 104 in the above embodiment, there is no limitation to this mode. For example, if one axial end part is supported by another member such as when an end part of a capacitor on the side of one axial end surface (negative electrode) is supported by an electrolyte container or if a sufficient fixing force can be obtained by press-fitting on one axial side, either one of a negative flat plate and a positive flat plate may be provided with press-fitting portions.

(2) Although the negative flat plate 90a is provided with the pair of projecting plate portions 94a, 94a projecting axially outward and the positive flat plate 90b is provided with the pair of projecting plate portions 94b, 94b projecting axially outward in the above embodiment, metal flat plates may not be provided with any projecting plate portions. For example, a metal flat plate extending straight in the front-rear direction may be provided, and press-fitting portions, connecting portions and stopper portions projecting downward may be provided in both end parts and a central part in a length direction of this metal flat plate. Even if the metal flat plate is provided with projecting plate portion(s), the projecting plate portion may be provided only on one side in the length direction of the metal flat plate. Further, even if the projecting plate portion is provided with press-fitting portion(s), the number of the press-fitting portions is not limited and may be one or more. That is, the shape of the metal flat plate and an arrangement mode of the connecting portion(s), the press-fitting portion(s) and the stopper portion(s) provided on the metal flat plate are not limited at all, but at least one connecting portion may be provided on each of the metal flat plates on both sides provided on respective electrodes and at least one press-fitting portion may be provided on at least one of the metal flat plates on the both sides provided on the respective electrodes. Further, the metal flat plate is not limited to the one including a through hole to be externally fit to each electrode, and a plurality of metal flat plates may be electrically conductively fixed to each electrode.

(3) In the above embodiment, the intermediate plate portion 116 is provided in the central part in the length direction of the positive flat plate 90b, this intermediate plate portion 116 is provided with the respective press-fitting portions 104 projecting downward, the respective projecting plate portions 94b are provided on the both end parts in the length direction of the positive flat plate 90b, and each of these projecting plate portions 94b is provided with the connecting portion 108 projecting downward. However, the projecting portions and the connecting portions may be reversely provided. That is, connecting portions may project downward toward a printed circuit board from a lower end part of an intermediate plate portion, which is a central part in a length direction of a positive flat plate, and press-fitting portions may project downward toward the printed circuit board from lower end parts of respective projecting plate portions. As just described, the connecting portions may be provided to project toward the printed circuit board from the lower end part of the central part in the length direction of the metal flat plate (e.g. positive flat plate 90b). In this way, the connecting portions can be provided at positions closer to the electrode (e.g. positive electrode 66b) and conduction efficiency is improved. Further, by similarly shaping a positive flat plate and a negative flat plate, providing projecting plate portions on both side parts in the length direction of the positive flat plate and providing each projecting plate portion with a press-fitting portion, each capacitor can be held on the printed circuit board at four positions separated from each other in the length direction (lateral direction) and the direction (front-rear direction) orthogonal to the length direction. In this way, each capacitor can be more stably held on the printed circuit board. Note that, similarly to the positive flat plate, at least one of a press-fitting portion, a connecting portion and a stopper portion may project downward toward the printed circuit board from a lower end part of a welded portion, which is a central part in a length direction of a negative flat plate.

(4) Although the plurality of (three) capacitors 16 are provided in the above embodiment, it is sufficient to provide at least one capacitor. Also when the plurality of capacitors are provided, all the capacitors need not be of the axial type, at least one capacitor may be of the axial type and the configuration of the present disclosure may be applied thereto.

(5) The capacitor is not limited to the electric double layer capacitor (EDLC) as in the above embodiment, and conventionally known capacitors (condensers) such as aluminum electrolytic condensers, film condensers and tantalum electrolytic condensers can be adopted. The capacitor is not limited to the type in which the electrolyte is enclosed, but may be a solid electrolytic condenser using a solid electrolyte.

(6) Although the negative electrode 66a is provided with the gas exhaust valve 88 in the above embodiment, a gas exhaust valve may be provided in a positive electrode and, in that case, an electrolyte container can be provided on the positive electrode side. Further, the structure of the gas exhaust valve is not limited. Although the three groove portions 86 constituting the gas exhaust valve 88 are arranged radially at intervals in the above embodiment, an arrangement mode of groove portions is not limited. For example, an I-shaped or cross-shaped groove portion may be provided or groove portions may extend from a center in five or more directions on a circumference. Further, although one electrolyte container 118 is provided for one capacitor 16 in the above embodiment, negative electrodes of three capacitors may be aligned at one side in the lateral direction and one electrolyte container may be provided to cover end parts on the negative electrode side of the three capacitors. Note that the electrolyte container is not essential in the power supply unit according to the present disclosure.

(7) Although the case 12 (upper case 20 and lower case 18) is made of synthetic resin and the upper case 20 and the lower case 18 are fixed by the engagement of the engaging protrusions 42 and the engaging frame bodies 26 in the above embodiment, there is no limitation to this mode. That is, an upper case and a lower case may be made of metal and, in that case, the upper case and the lower case can be, for example, fixed by bolts.

### LIST OF REFERENCE NUMERALS

10 power supply unit
12 case
14 printed circuit board
16 capacitor
18 lower case
20 upper case
22 bottom wall portion
24 lower peripheral wall portion
26 engaging frame body
28 lower contact portion
30 upper bottom wall portion
32 upper peripheral wall portion
34 upper contact portion
36 screw hole
37 positioning pin
38 upper supporting portion
40 recess
42 engaging protrusion
44 connector
46 opening
48 through-hole
50 press-fitting hole
52 press-fitting hole
54 fitting hole
56 screw
58 screw hole
60 positioning hole
62 tubular body
64 axial end surface
64a one end surface
64b other end surface
66 electrode
66a negative electrode
66b positive electrode
68 electrolyte
70 capacitor case
72 through hole
74 terminal plate
76 flange-like portion
78 projecting portion
80 insulation layer
82 covering rubber layer
84 insertion hole
85 lead wire
86 groove portion
88 gas exhaust valve
90 metal flat plate
90a negative flat plate
90b positive flat plate
92a, 92b welded portion
94a, 94b projecting plate portion
96 through hole
98 guiding groove (concavely bent part)
100 extending portion
102 downward projecting portion
103 cut portion
104 press-fitting portion
106 solder
108 connecting portion
110 stopper portion
112, 114 gap
116 intermediate plate portion
118 electrolyte container
120 bottom wall
122 peripheral wall
124 outer wall portion
126 inner wall portion
128 side wall portion
129 recess
130 press-fitting leg portion
132 fitting leg portion
134 inserting portion
136 large-diameter portion
138 outer side portion
140 inner side portion
142 locking claw

1. A power supply unit, comprising:
a printed circuit board accommodated in a case; and
a capacitor mounted on the printed circuit board,
the capacitor including a pair of electrodes on both end surfaces in an axial direction of a tubular body,
a metal flat plate being electrically conductively fixed to each electrode,
each metal flat plate including a connecting portion to be inserted into and soldered to a through-hole of the printed circuit board,
at least one of the metal flat plates including a press-fitting portion to be press-fit into a press-fitting hole of the printed circuit board, and
the capacitor being fixedly held on the printed circuit board by press-fitting the press-fitting portion into the press-fitting hole.

2. The power supply unit of claim 1, wherein each metal flat plate includes the press-fitting portion.

3. The power supply unit of claim 1, wherein each metal flat plate includes a stopper portion for specifying an insertion amount of the connecting portion into the through-hole by being placed on the printed circuit board and a gap spreading upward is formed around the connecting portion with the stopper portion placed on the printed circuit board.

4. The power supply unit of claim 3, wherein the press-fitting portion press-fit into the press-fitting hole is soldered and a gap spreading upward is formed around the press-fitting portion with the stopper portion placed on the printed circuit board.

5. The power supply unit of claim 1, wherein a central part in a length direction of the metal flat plate including the press-fitting portion constitutes a welded portion to be overlapped on and welded to the electrode, both side parts in the length direction thereof constitute a pair of projecting plate portions projecting outward in the axial direction of the tubular body by being bent in a plate thickness direction, the press-fitting portion is provided to project toward the printed circuit board from a lower end part of each of the pair of projecting plate portions, and each press-fitting portion is press-fit into the press-fitting hole. pcm 6. The power supply unit of claim 1, wherein each metal flat plate includes a stopper portion for specifying an insertion amount of the connecting portion into the through-hole by being placed on the printed circuit board, a central part in a length direction thereof constitutes a welded portion to be overlapped on and welded to the electrode, both side parts in the length direction thereof constitute a pair of projecting plate portions projecting outward in the axial direction of the tubular body by being bent in a plate thickness direction, and the stopper portion is provided to project toward the printed circuit board from a lower end part of each of the pair of projecting plate portions.

7. The power supply unit of claim 5, wherein the connecting portion is provided to project toward the printed circuit board from a lower end part of the central part in the length direction of the metal flat plate.

8. The power supply unit of claim 5, wherein:
a gas exhaust valve for discharging a gas generated at time of abnormality is provided in one of the both end surfaces of the capacitor,
the welded portion of the metal flat plate is arranged around the gas exhaust valve,
guiding grooves for guiding an electrolyte by extending toward the printed circuit board are constituted by a pair of concavely bent parts coupling the welded portion of the metal flat plate and the pair of projecting plate portions, and
each projecting plate portion is provided with the connecting portion and a cut portion and the guiding groove and the connecting portion are separated in the axial direction by the cut portion.

9. The power supply unit of claim 8, wherein an electrolyte container for storing the electrolyte oozing out from the gas exhaust valve is arranged below the gas exhaust valve and the guiding grooves on the printed circuit board.

10. The power supply unit of claim 1, wherein:
a gas exhaust valve for discharging a gas generated at time of abnormality is provided in one of the both end surfaces of the capacitor, and
an electrolyte container for storing an electrolyte discharged from the gas exhaust valve is arranged below the gas exhaust valve on the printed circuit board.
